(19) United States
(12) Patent Application Publication
(10) Pub. No.: US 2008/0155426 A1
(43) Pub. Date: Jun. 26, 2008

(54) Visualization and navigation of search results

(75) Inventors: George G. Robertson, Seattle, WA (US); Daniel Chaim Robbins, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/643,559

(22) Filed: Dec. 21, 2006

(51) Int. Cl. G06F 3/00

(52) U.S. Cl. 715/738

(57) ABSTRACT

Methods and computer-readable media are provided for the visualization and navigation of search results. Scaled visual representations of multiple search results may be displayed on a single display screen. The scaled visual representations of the search results may be organized by category. A user may fluidly zoom the display into a full-scale visual representation of a particular search result, fluidly zoom the display into visual representations of search results within a particular category, obtain scaled visual representations of additional search results within a particular category, or obtain scaled visual representations of search results within one or more sub-categories.

### BACKGROUND

Search engines are some of the most frequently utilized sites on the World Wide Web (the “Web”). Internet search engines allow a user to enter search terms and, based on the search terms, perform a query of a database of Web pages available on the Internet. Search results identifying Web pages matching the search terms are then returned to the user. In most cases, the search results are returned as a simple list of page titles ordered by relevance to the search terms. Search results returned in this manner frequently require a user to browse through multiple pages of search results and to visit many of the Web pages identified in the search results in order to locate relevant information.

Research has shown that users are better able to utilize search results that are organized into meaningful categories. Although such category-based search result user interfaces do provide some improvement over search results that are not organized by category, these types of user interfaces also suffer from a number of drawbacks. The main drawback is that category-based search result user interfaces, and most other search result displays, require a user to visit the Web page corresponding to each search result to determine if the Web page is actually relevant. Visiting each Web page identified within a collection of search results in this manner is costly in terms of time, bandwidth, and efficiency.

Another user interface for navigating among search results utilizes a computer system having a large number of display devices. For instance, such a computer system may be equipped with nine or more display screens. In such a system, the actual Web pages corresponding to the search results are retrieved and displayed rather than just the page titles. When a search is performed on such a system having N monitors, each of the first N−1 search results are displayed individually on a dedicated display screen. The remaining display screen is reserved for collecting results that may be explored in greater depth at a later time.

Multi-monitor search result user interfaces also suffer from a number of drawbacks, however. In particular, these systems do not organize search results by category, which may result in a user having to explore each result in detail to determine its relevancy. Moreover, these systems rely on a large number of display devices and upon a one-to-one size relationship between the multiple page view and viewing a particular result for detailed work. As a result, these types of user interfaces only work on computer systems having a significant number of display devices. These systems are therefore very expensive and also consume a large amount of space.

It is with respect to these considerations and others that the disclosure made herein is provided.

### SUMMARY

Methods and computer-readable media are provided herein for visualizing and navigating search results. Through the embodiments presented herein, scaled visual representations of multiple search results are displayed on a single display screen, thereby obviating the need for multiple display devices. The scaled visual representations of the search results are organized by category, thereby making it easier for a user to determine whether each search result is relevant. A user may also zoom into a particular search result or category of search results, obtain additional search results in a particular category, and obtain search results within sub-categories.

According to one aspect presented herein, methods are provided for visualizing and navigating a collection of search results. In one method, scaled visual representations of a subset of the search results are rendered. For instance, scaled visual representations may be rendered for the first ten search results. The scaled visual representations are then simultaneously displayed on a single display screen. In this manner, the contents of the actual search results are visible, rather than just page titles, and may be utilized by a user to determine the relevancy of each of the search results. Scaled visual representations of additional search results may be requested by a user and displayed in a similar manner.

According to other aspects, the collection of search results may be organized into groups based upon one or more categories. In this embodiment, each scaled visual representation of a search result is displayed in a group. The group for each visual representation is determined based upon the category assigned to the corresponding search result. A category name or other identifier may also be displayed adjacent to each group of scaled visual representations of search results. By organizing the scaled visual representations of the search results into categories, a user can more easily focus on the search results relevant to their particular query.

According to additional aspects, a request may be received to view a full-scale representation of one of the search results. For instance, a user may select a scaled visual representation of a search result using a mouse or other user input device to request a full-scale representation of the corresponding search result. In response to such a request, the display is fluidly zoomed into the selected scaled visual representation to thereby display a full-scale representation of the corresponding search result. The full-scale representation may be viewed temporarily, or may be more fully explored, navigated, and otherwise utilized by the user. A request may also be received to return to the scaled visual representations of the search results. In response to such a request, the display is fluidly zoomed out of the full-scale visual representation of the selected search result to thereby display the scaled visual representations of the search results.

According to other aspects, a request may be received to view additional detail for one of the categories. For instance, a category name may be selected to view additional detail regarding the search results in the corresponding category. In response to such a selection, the display may be fluidly zoomed in to show only scaled visual representations of search results in the selected category. In one implementation, the scale of the visual representations is increased to provide additional detail regarding the search results in the selected category. Scaled visual representations may also be displayed for additional search results in the selected category. Additional details regarding a category may be viewed temporarily or permanently.

According to further aspects, each category of search results may be further divided into sub-categories. In response to receiving a request to view additional detail for one of the categories, scaled visual representations of search results in sub-categories of the selected category may be displayed. Search results within the selected sub-category may then be explored in a similar manner.

The above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network and software diagram showing an illustrative operating environment for the processes and computer systems described herein and several of the software components utilized by the computer systems described herein;

FIGS. 2A-2C, 3A-3G, and 4A-4C are screen diagrams showing illustrative screen displays provided by the embodiments presented herein for visualizing and navigating search results;

FIGS. 5A-5B are flow diagrams illustrating various processes provided herein for visualizing and navigating search results; and

FIG. 6 is a computer architecture diagram showing a computer architecture suitable for implementing the various computer systems described herein.

### DETAILED DESCRIPTION

The following detailed description is directed to systems, methods, and computer-readable media for visualizing and navigating search results. As will be discussed in greater detail below, scaled visual representations of multiple search results may be displayed on a single display screen and organized by category. A user may fluidly zoom the display into a full-scale visual representation of a particular search result, fluidly zoom the display into visual representations of search results within a particular category, obtain scaled visual representations of additional search results within a particular category, or obtain scaled visual representations of search results within one or more sub-categories. While the subject matter described herein is presented in the general context of program modules that execute in conjunction with the execution of an operating system and application programs on a computer system, those skilled in the art will recognize that other implementations may be performed in combination with other types of program modules.

Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

The subject matter described herein is also described as being practiced in a distributed computing environment where tasks are performed by remote processing devices that are linked through a communications network and wherein program modules may be located in both local and remote memory storage devices. It should be appreciated, however, that the implementations described herein may also be utilized in conjunction with stand-alone computer systems and other types of computing devices. It should also be appreciated that although reference is made herein to the Internet, the embodiments presented herein may be utilized with any type of local area network (“LAN”) or wide area network (“WAN”).

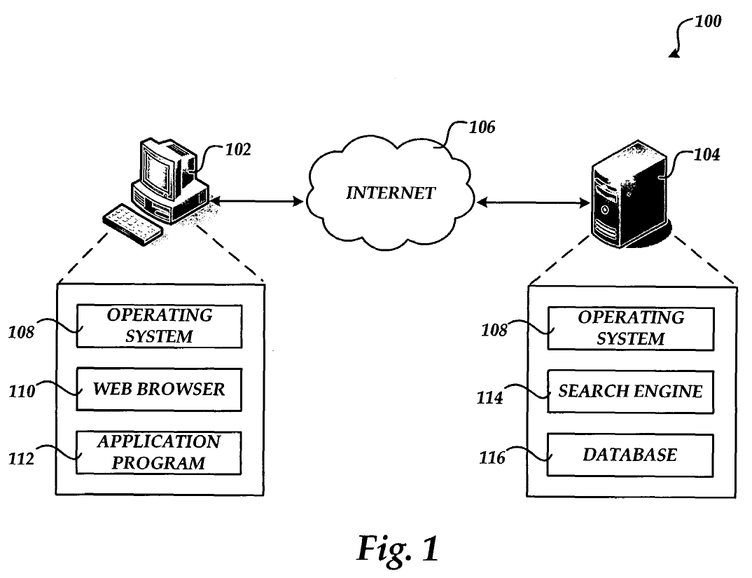

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for visualizing and navigating search results will be described. In particular, FIG. 1 is a network diagram illustrating aspects of an illustrative operative environment for the subject matter described herein that includes a client computer 102, a server computer 104, and a network 106.

As shown in FIG. 1, the client computer 102 and the server computer 104 are communicatively coupled to one another through respective connections to the network 106. According to one implementation, the network 106 comprises the Internet. However, it should be appreciated that the network 106 may comprise a LAN, WAN, or other type of suitable network for connecting the client computer 102 and the server computer 104.

FIG. 1 also illustrates a number of software components utilized by the client computer 102 and the server computer 104. In particular, the client computer 102 includes an operating system 108 suitable for controlling the operation of a networked desktop or laptop computer. The server computer 104 includes an operating system 108 suitable for controlling the operation of a networked server computer. For instance, according to implementations, both the client computer 102 and server computer 104 may utilize the WINDOWS XP or WINDOWS VISTA operating systems from MICROSOFT CORPORATION of Redmond, Wash. Other operating systems, such as the LINUX operating system or the OSX operating system from APPLE COMPUTER, INC. may be utilized. It should be appreciated that although the embodiments presented herein are described in the context of a desktop or laptop client computer 102 and a remote server computer 104, many other types of computing devices and systems may be utilized to embody the various aspects presented herein.

According to one implementation, the client computer 102 also includes a Web browser program (referred to herein as a “browser”) 110. The browser 110 is operative to request, receive, and display information pages, such as Web pages, from the server computer 104. In particular, the browser 110 is operative to establish a connection with a search engine 114 executing on the server computer 104. Through the connection, the browser 110 may request a Web page for executing a search query provided by the search engine 114. Through the Web page, a user of the client computer 102 can specify one or more search terms to be utilized by the search engine 114 in a search of the database 116. In one embodiment presented herein, the database 116 includes data regarding Web pages and other types of documents located on the Internet. It should be appreciated, however, the database 116 may include virtually any kind of data including, but not limited to Web pages, documents, images, and multimedia files.

In response to performing a query, the search engine 114 is operative to return a collection of search results. In one embodiment, the search results identify Web pages stored on the Internet using a uniform resource locator (“URL”) and may be ordered by relevance to the search terms. According to one implementation, the search results may also be grouped according to categories and sub-categories. For instance, a search for the term “jaguar” may return search results sorted into categories corresponding to animals, automobiles, or sports teams. Each category may be further defined into sub-categories. Once the search has been performed and the results categorized, the category names and the URLs of the search results in each category are returned to the client computer 102.

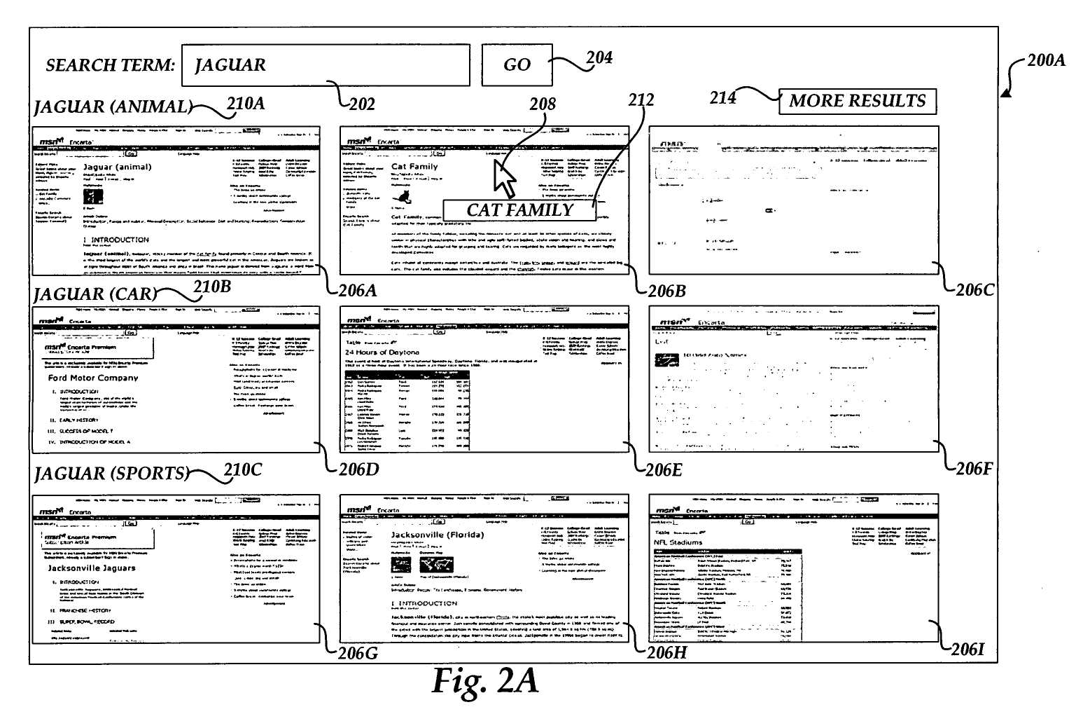

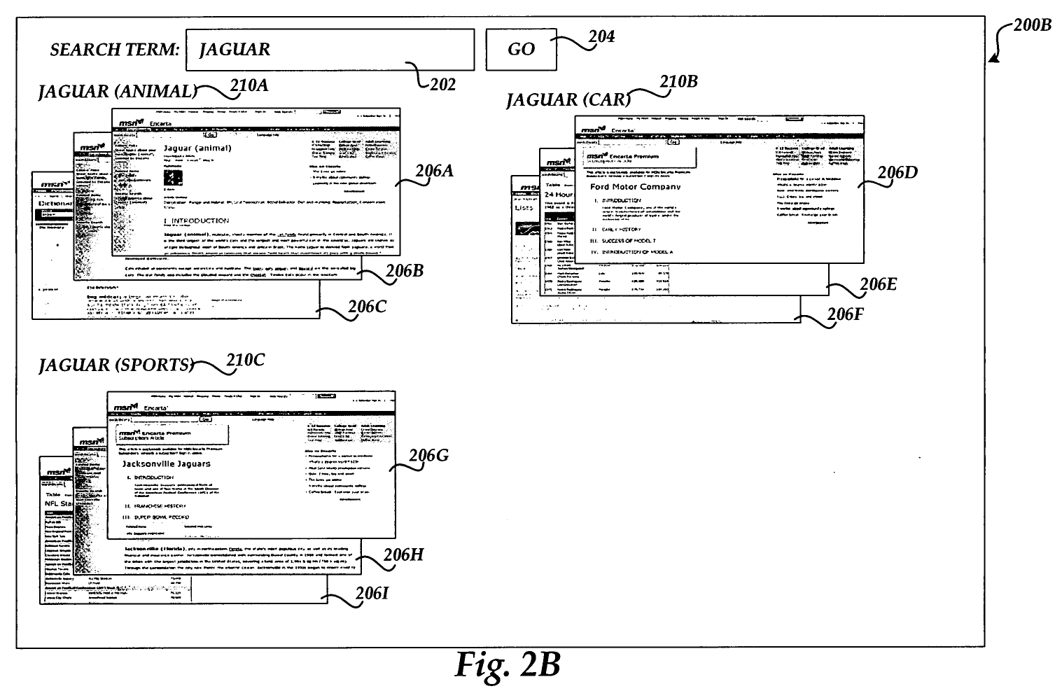

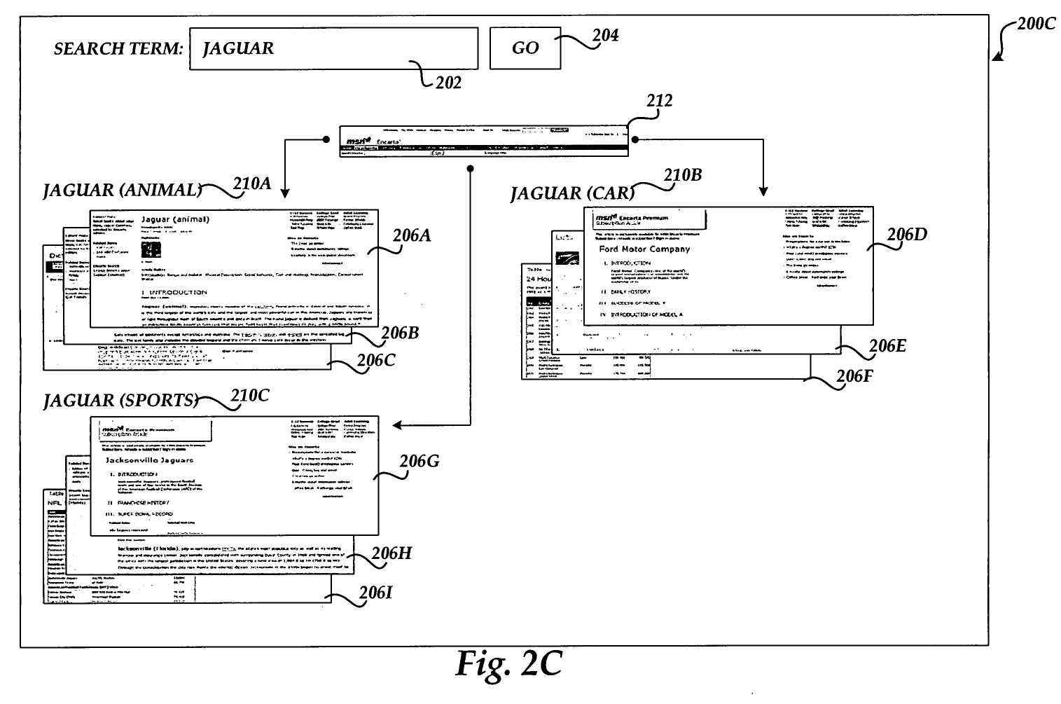

As will be described in greater detail below, a user interface is provided by the client computer 102 for visualizing and navigating the search results provided in response to a search query. In one implementation, the user interface includes scaled visual representations of the search results returned in response to a search query performed in the manner described above. The scaled visual representations are generated by retrieving the Web pages corresponding to the search results, rendering the Web pages, and then scaling the rendered Web pages down so that multiple representations may be presented on a single display of the client computer 102. In one implementation, the Web browser 110 performs these processing operations. It should be appreciated, however, that in other implementations, the operating system 108 or an application program 112 executing on the client computer 102 perform some or all of these processing operations. Alternatively, the server computer 104 may perform some or all of these processing operations. FIGS. 2A-2B, 3A-3G, 4A-4C, and 5A-5B, which are described below, provide additional details regarding the structure and use of the various user interfaces provided herein for visualizing and navigating search results.

Referring now to FIG. 2A, aspects of an illustrative display 200A generated by one user interface provided herein will be described. In particular, FIG. 2A shows a display 200A generated by the browser 110 following the execution of a query by the server computer 104 using the illustrative search term “jaguar.” As shown in FIG. 2A, the display 200A includes a field 202 for receiving the search terms and a user interface button 204 which, when selected, will cause the entered search terms to be transmitted to the search engine 114 along with a request to perform a search of the database 116 using the provided search terms. In response to such a request, the search engine 114 performs a search of the database 116 and returns the search results to the browser 110 in the manner described above. The browser 110 then generates the display 200A shown in FIG. 2A using the returned search results.

In one embodiment, the display 200A includes the scaled visual representations 206A-206I of the returned search results. The scaled visual representations 206A-206I are visual renderings of the Web pages identified by the search results that have been scaled down to fit simultaneously within the display 200A. According to implementations, the scaled visual representations 206A-206I are organized into groups on the display 200A by category. For instance, the scaled visual representations 206A-206C are in one group corresponding to the animal category, the scaled visual representations 206D-206F are in a second group corresponding to an automobile category, and the scaled visual representations 206G-206I are in a third group corresponding to a sports team category. The category names 210A-210C may be displayed adjacent to each group of scaled visual representations.

It should be appreciated that although the display 200A shown in FIG. 2A shows three scaled visual representations in three different groups, more or fewer results and groups may be displayed. The number of scaled visual representations and groups shown may be computed as a function of the resolution of the screen display upon which they are shown. A scale factor for computing the dimensions of each of the scaled visual representations may also be determined based upon the number of representations to be displayed, the number of categories, and the resolution of the screen display. A user interface button 214 may also be provided in one implementation for retrieving the next most relevant search results and displaying them in the same manner as illustrated in FIG. 2A.

According to one aspect of the disclosure presented herein, a user input device, such as a mouse, keyboard, touch screen, touch pad, or other similar device, may be utilized to control the location of a pointer (referred to herein as a “pointer”) 208 on the display 200A. Such a user input device may also be utilized to make a selection of a user interface object shown on the display 200A. For instance, where the user input device is a mouse, one of the buttons on the mouse may be utilized to select objects shown on the display 200A.

The pointer 208 may also be placed over a user interface object without selecting the object. This process is referred to herein as “hovering.” In one implementation, a user interface object showing the page title of the corresponding search result is displayed when the pointer 208 is hovered over a scaled visual representation. For instance, in the example shown in FIG. 2A, the pointer 208 is hovering over the scaled visual representation 206B. As a result, the user interface object 212 is displayed that shows the title of the search result corresponding to the scaled visual representation 206B.

Turning now to FIG. 2B, another illustrative display 200B generated by the browser 110 following the execution of a search will be described. In this implementation, the scaled visual representations 206A-206I are still shown within groups corresponding to categories of search results. However, in this embodiment, the scaled visual representations 206A-206I of the search results have been displayed in stacks of overlapping search results rather than in the tiled fashion shown in FIG. 2A. As will be described in greater detail below, one of the category names 210A-210C may be selected using the user input device to focus on the results in the selected category. In response to such a selection, the scaled visual representations in the selected category will be reorganized from stacks into a tiled arrangement so that each scaled visual representation within the selected group can be viewed in its entirety.

Referring now to FIG. 2C, another illustrative display 200C generated by the browser 110 following the execution of a search will be described. In this implementation, the common portions of each of the scaled visual representations 206A-206I are shown in a header 212. In this manner, the common elements (e.g. branding, user interface, common advertisements, etc.) are collapsed into the header 212 and displayed only once. These elements are not shown in each of the scaled visual representations 206A-206I. Only the elements of each of the scaled visual representations 206A-206I that are different are displayed separately.

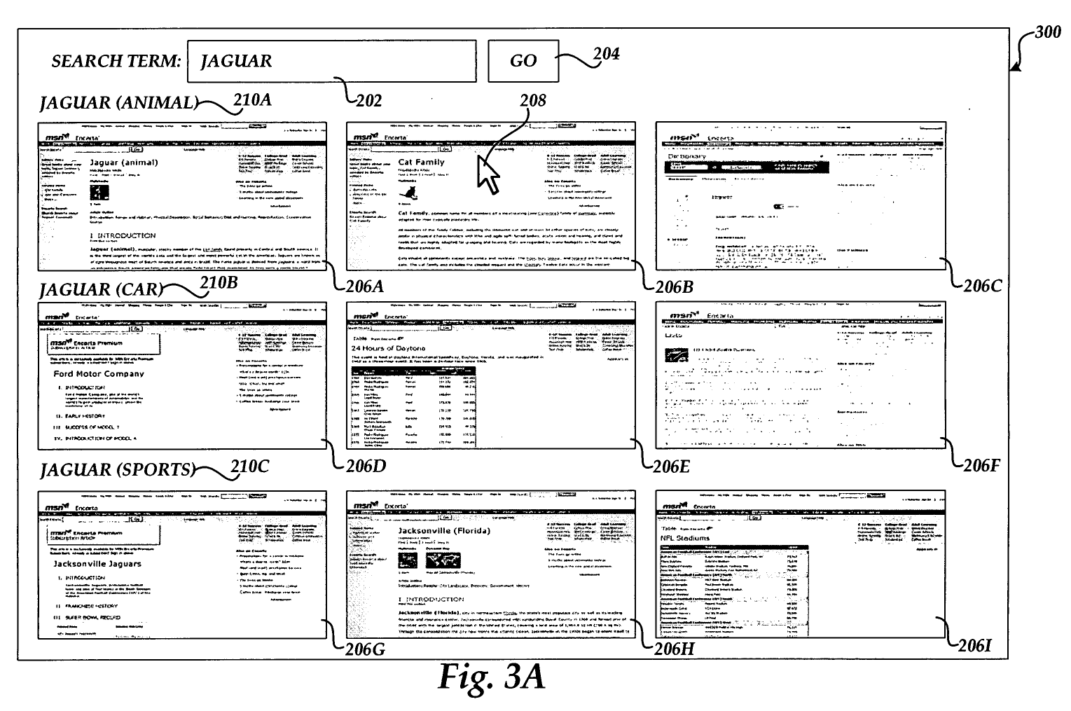

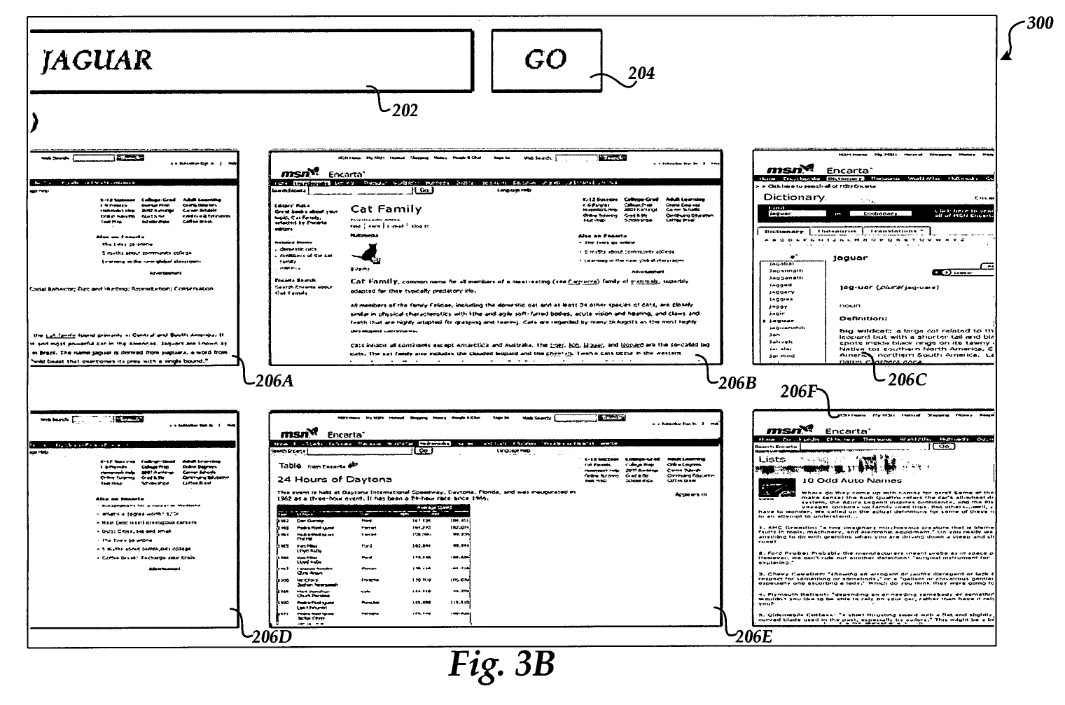

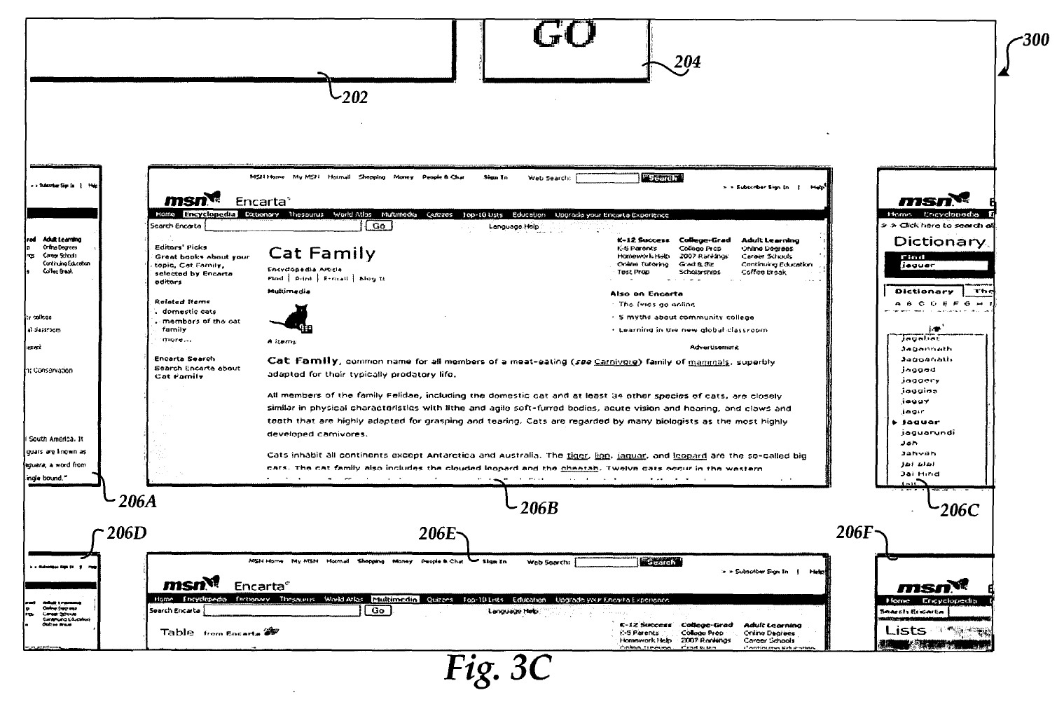

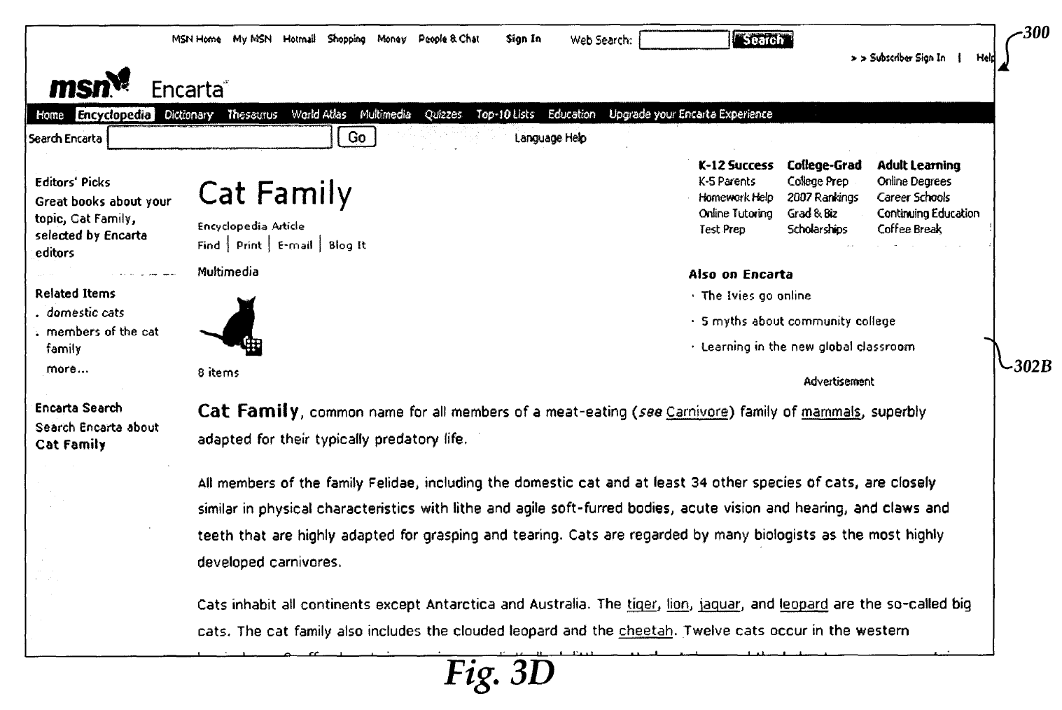

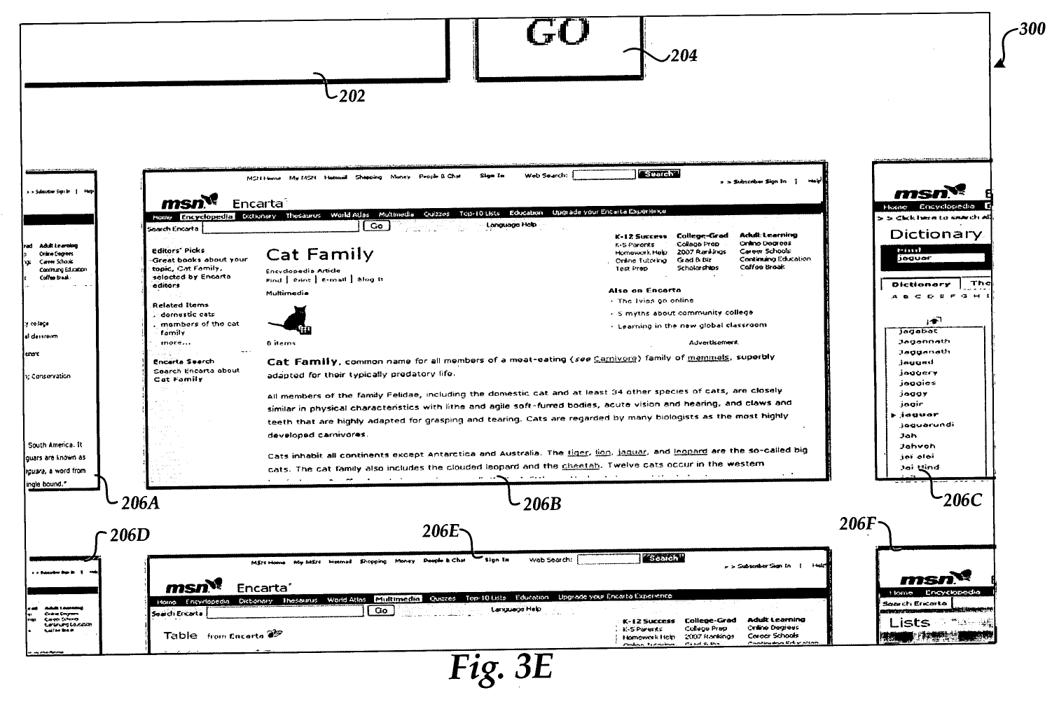

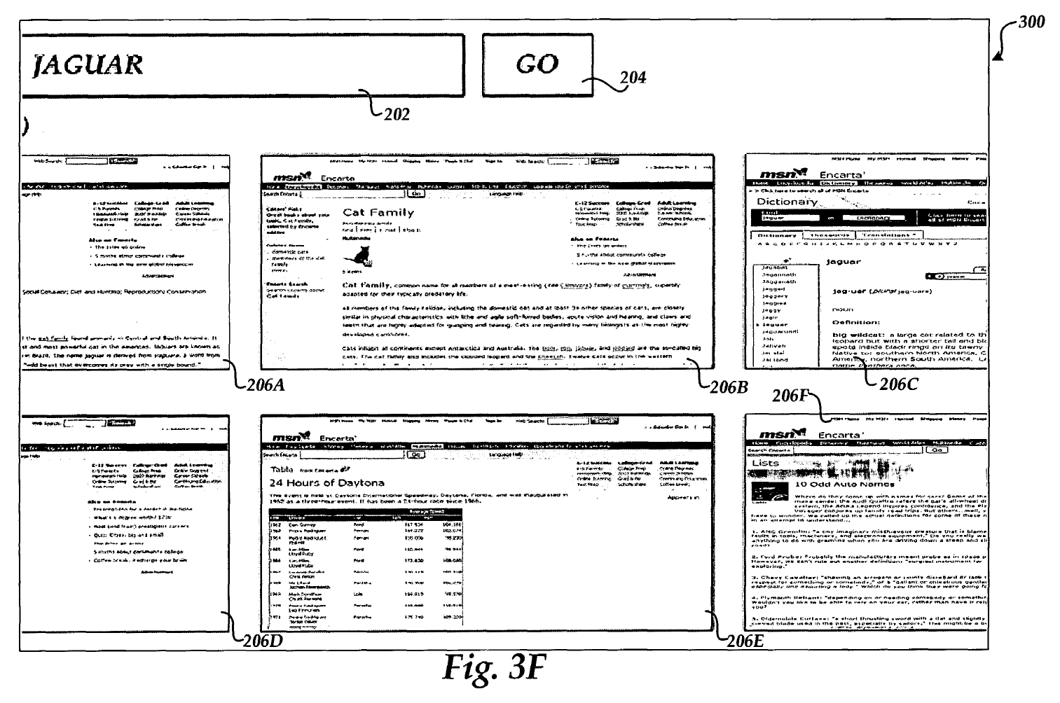

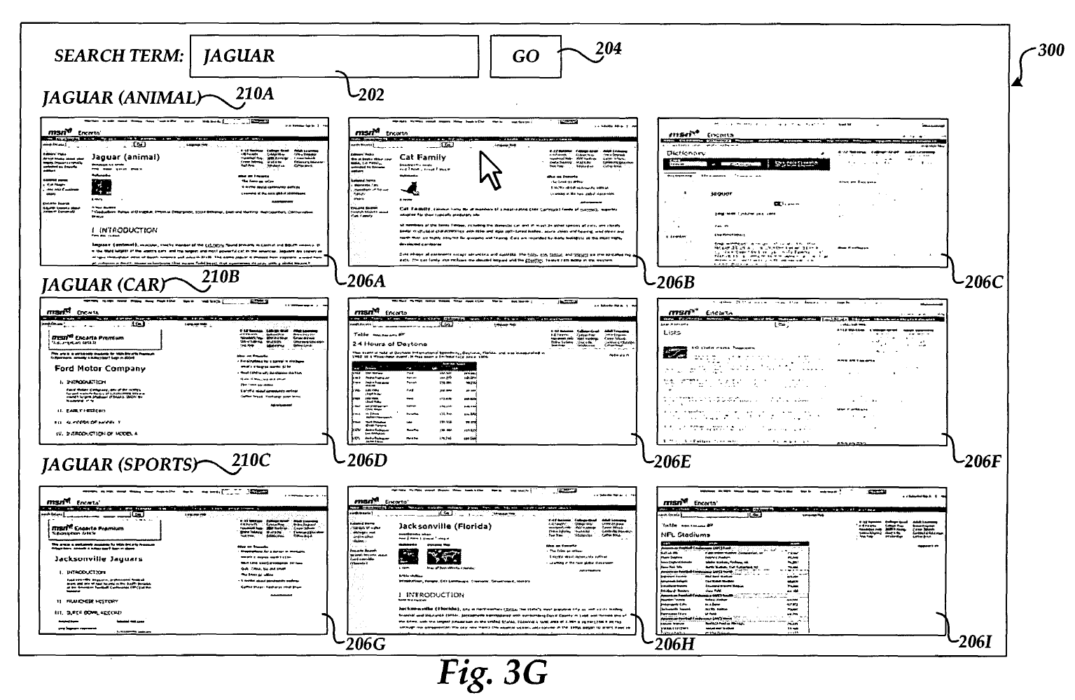

Referring now to FIGS. 3A-3G, additional details will be provided regarding one aspect of the disclosure presented herein for navigating search results. In particular, FIG. 3A shows a screen display 300 generated by the browser 110 following the execution of a sample search query for the term “jaguar.” In this implementation, a user may utilize a user input device to select one of the scaled visual representations 206A-206I in order to fluidly zoom the display 300 into a full-scale representation of the selected scaled visual representation. Zooming into the selected scaled visual representation causes the selected representation to be displayed as a full-scale representation using the entire area of the display 300.

In the example shown in FIGS. 3A-3G, a user has selected the scaled visual representation 206B using the pointer 208. In response to such a selection, the display 300 is fluidly zoomed into a full-scale representation 302B of the selected visual representation 206B. This process is illustrated in FIGS. 3A-3D. It should be appreciated that although the zooming process is shown at discrete levels of zoom in FIGS. 3A-3D, the zooming is performed in a fluid manner. In order to provide the fluid panning and zooming capabilities described herein, the embodiments presented herein utilize algorithms that allow for fluid and continuous transitions between zoom levels. This process is described in one or more of U.S. Pat. No. 7,075,535, filed Mar. 1, 2004, and entitled “System and Method for Exact Rendering in a Zooming User Interface,” U.S. patent application Ser. No. 11/208,826, filed Aug. 22, 2005, and entitled “System and Method for Upscaling Low-Resolution Images,” Provisional U.S. Patent Application No. 60/619,053, filed Oct. 15, 2004, and entitled “Nonlinear Caching for Virtual Books, Wizards or Slideshows,” Provisional U.S. Patent Application No. 60/619,118, filed on Oct. 15, 2004, and entitled “System and Method for Managing Communication and/or Storage of Image Data,” and Provisional U.S. Patent Application No. 60/666,142, filed Mar. 29, 2005, and entitled “System and Method for Interactive Multiresolution Transfer of World Wide Web Content By Proxy,” each of which is expressly incorporated herein by reference in its entirety.

Once the display 300 has zoomed in on the selected scaled visual representation 206B, as shown in FIG. 3D, a user may view, navigate, and otherwise interact with the full-scale representation 302B of the corresponding search result. When the user has completed their interaction, the user may utilize a user input device to request that the display 300 be returned to the search result display shown in FIG. 3A. In response to such a request, the display 300 is fluidly zoomed out of the full-scale representation 302B to return to the search result display shown in FIG. 3B. The process of fluidly zooming out of the full-scale representation 302B to show the search result display is illustrated in FIGS. 3E-3G.

According to one implementation, a user may request to zoom into a scaled visual representation only temporarily. This may be accomplished, for instance, by pressing and holding a mouse button or by holding down a command key while selecting the desired scaled visual representation. In response to such a selection, the display 300 is fluidly zoomed into the selected scaled visual representation temporarily for examination. When the user has finished examining the selected scaled visual representation, the user may release the mouse button or perform another function to cause the display 300 to fluidly zoom back to the category display shown in FIG. 3A.

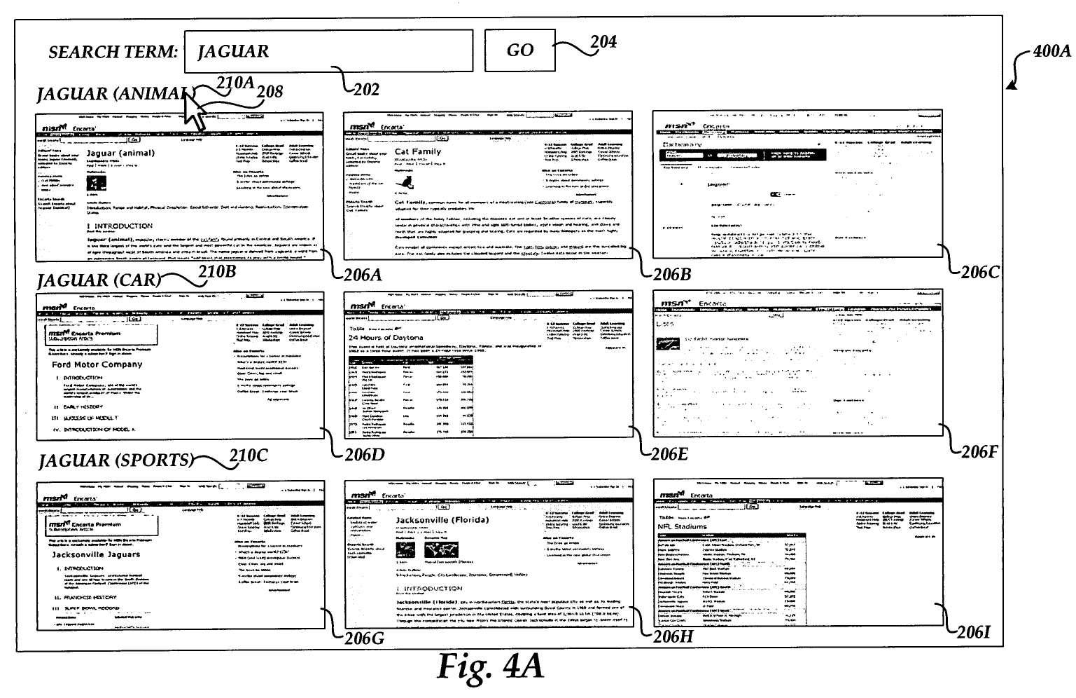

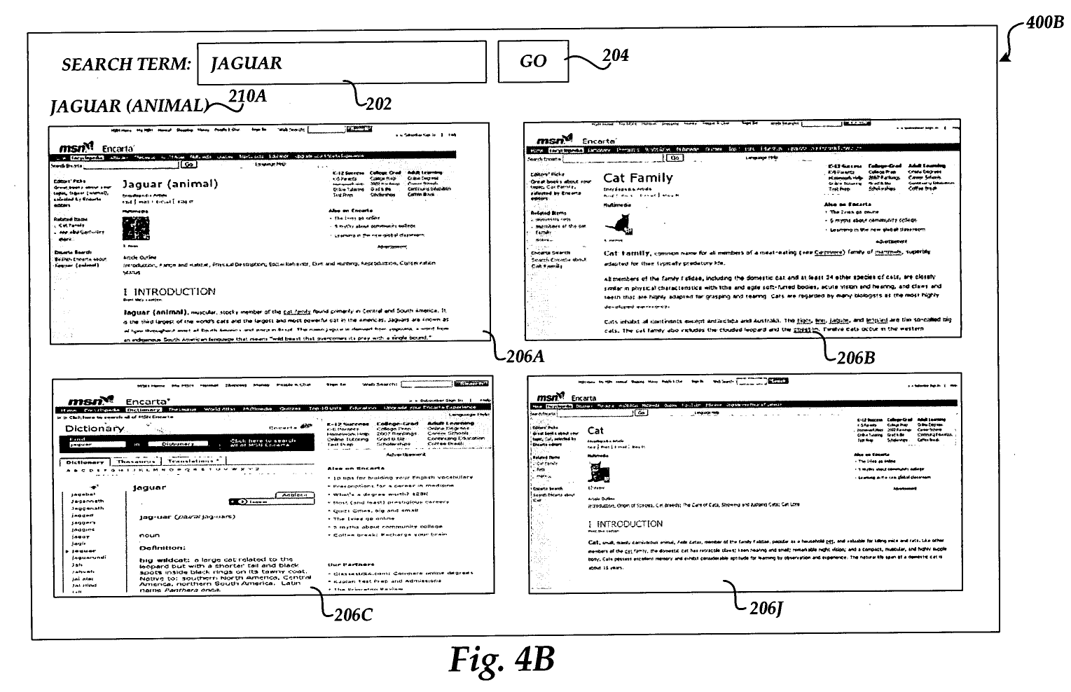

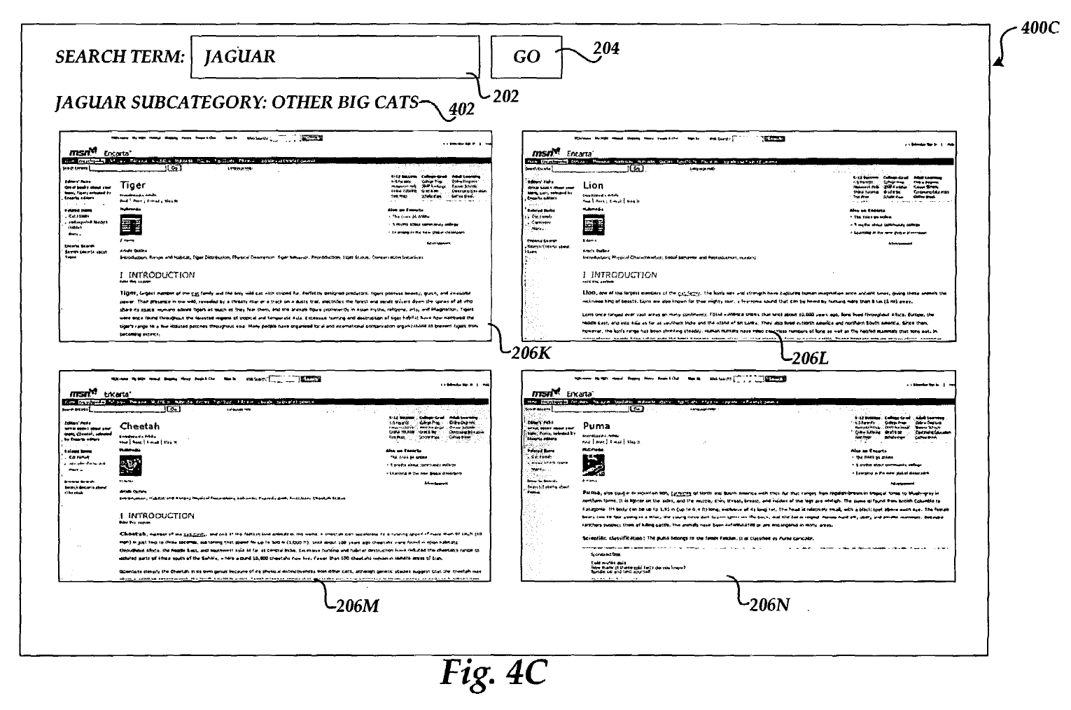

Turning now to FIGS. 4A-4C, additional details will be provided regarding one aspect of the disclosure presented herein for navigating search results. In particular, FIG. 4A shows a screen display 400A generated by the browser 110 following the execution of a sample search query for the term “jaguar.” In this implementation, a user may utilize a user input device to request additional details for one of the categories by selecting one of the category names 210A-210C with the pointer 208. In response to such a selection, the display 400A fluidly zooms in to shown only the search results within the selected category. For instance, in the example shown in FIG. 4A, a user has selected the category name 210A. In response thereto, the display 400A is fluidly zoomed into the display 400B, shown in FIG. 4B, which includes the scaled visual representations 206A-206C and 206J corresponding to search results within the selected category. If the scaled visual representations are stacked in the manner described above with respect to FIG. 3B, they will be tiled when the display is zoomed into the selected category.

As shown in FIG. 4B, when the display 400A is zoomed in to show only the results within a particular category, the scaled visual representations for the category are displayed at a larger size than in the search result view shown in FIG. 4A. In this manner, greater detail is made available to the user while zoomed in on a particular category. Additionally, according to one implementation, additional search results may be represented when the display 400A is zoomed into a particular category. For instance, in the example shown in FIG. 4B, an additional search result represented by the scaled visual representation 206J has been displayed. Any number of additional search results for the selected category may be displayed in a similar manner. Any of the scaled visual representations 206A-206C and 206J may be selected and zoomed into in the manner described above. Additionally, a user interface object may be presented on the display 400B that allows a user to retrieve additional results within the selected category.

According to another implementation, each category may be sub-divided into sub-categories. In this implementation, selection of a category name 210A will cause the display 400A to be fluidly zoomed in to show results within sub-categories of the selected category. For instance, as shown in FIG. 4C, the results within a subcategory have been displayed within the display 400C in response to the selection of the category name 210A. These results are represented by the scaled visual representations 206K-206N. If the scaled visual representations are stacked in the manner described above with respect to FIG. 3B, they will be tiled when the display is zoomed into the selected sub-category. It should be appreciated that any of the scaled visual representations 206K-206N may be selected and zoomed into in the manner described above. Additionally, a user interface object may be presented on the display 400C that allows a user to retrieve additional results within the selected sub-category.

According to one implementation, a user may request to zoom into the results within a particular category or sub-category only temporarily. This may be accomplished, for instance, by pressing and holding a mouse button or by holding down a command key while selecting the desired category or sub-category. In response to such a selection, the display 400A is fluidly zoomed into results within the selected category or sub-category for examination. When the user has finished examining the selected category or sub-category, the user may release the mouse button to cause the display 400B or 400C to fluidly zoom back to the search result display shown in FIG. 4A.

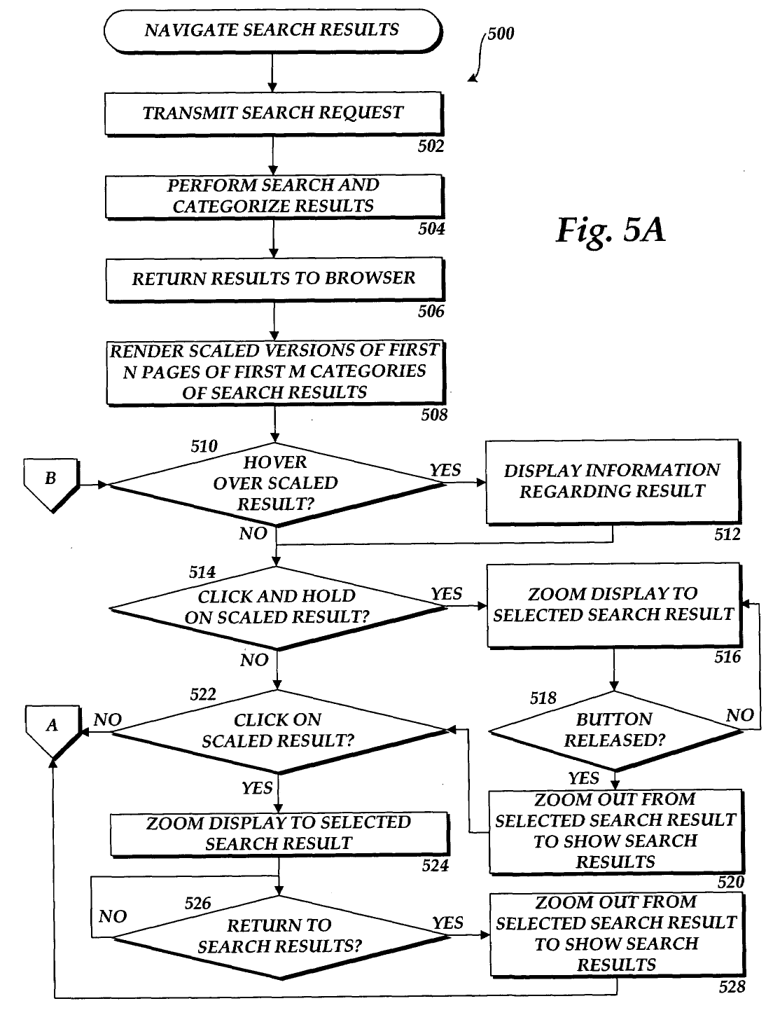

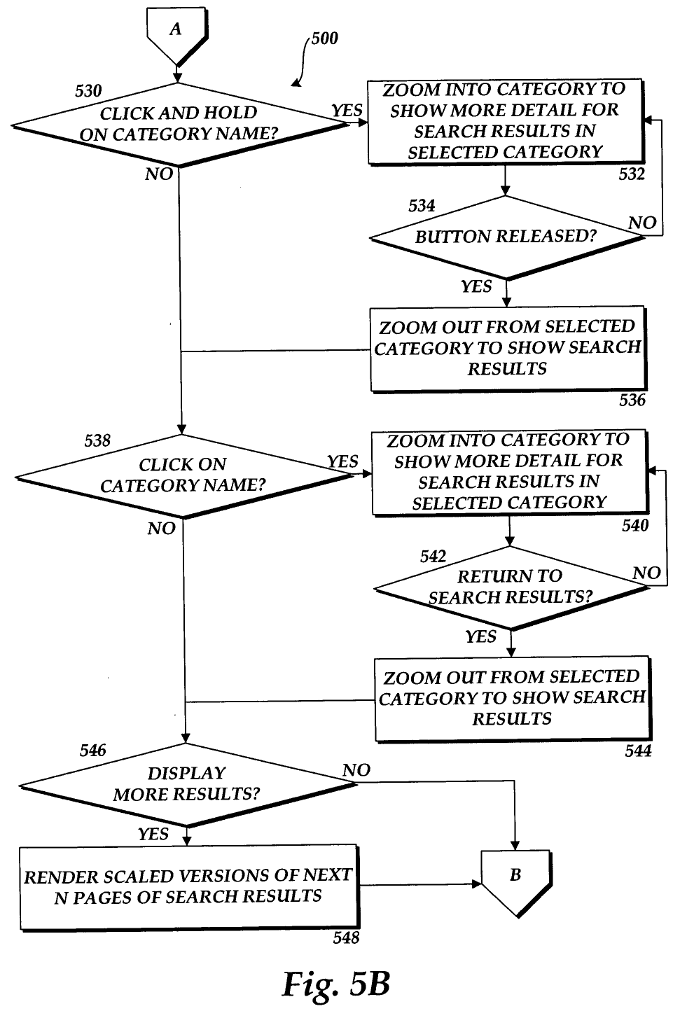

Referring now to FIGS. 5A-5B, additional details will be provided regarding the embodiments presented herein for visualizing and navigating search results. In particular, FIGS. 5A-5B are flow diagrams showing a routine 500 that illustrates the operation of the client computer 102 for visualizing search results and allowing a user to visually navigate the search results according to one implementation. As mentioned briefly above, it should be appreciated that some or all of the processing operations shown in FIGS. 5A-5B and described herein as being performed by the client computer 102 may be performed by the server computer 104 in alternate implementations. For instance, the server computer 104 may render the scaled visual representations of the search results as images and provide facilities for allowing the client computer 102 to fluidly zoom into and out of the rendered images.

It should also be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance requirements of the computing system. Accordingly, the logical operations described herein are referred to variously as operations, structural devices, acts, or modules. These operations, structural devices, acts and modules may be implemented in software, in firmware, in special purpose digital logic, and any combination.

The routine 500 begins at operation 502, where the browser 110 is utilized to request a search of the database 116 by the search engine 114. In response thereto, the search engine 114 performs the requested search and categorizes the search results at operation 504. The server computer 104 transmits the categorized search results to the browser 110 at operation 506. As discussed above, in one embodiment the search results are categorized and include a URL and page title for each search result. The search engine 114 may return the first N results with the response to the search request. Additional results may be obtained by making subsequent requests to the search engine 114.

From operation 506, the routine 500 continues to operation 508, where the browser 110 renders the scaled visual representations of the search results. In order to render the scaled visual representations, the browser 110 retrieves the Web page for each result from the specified URL, renders the page, and scales the rendered image. As discussed above, in other embodiments, software components executing on the server 104 may perform the rendering process. Once the scaled visual representations have been rendered, the browser 110 displays the scaled visual representations in groups assigned according to category in the manner described above with respect to FIG. 2A.

From operation 508, the routine 500 continues to operation 510, where the browser 110 determines whether the pointer 208 is hovering over a scaled visual representation. If so, the routine 500 branches to operation 512, where data is displayed regarding the corresponding search result in the manner described above with respect to FIG. 2A. If not, the routine 500 continues from operation 510 to operation 514.

At operation 514, the browser 110 determines whether a request has been made to temporarily zoom into one of the scaled visual representations. As discussed above, such a selection may be made in one embodiment by placing the pointer 208 on a scaled visual representation and clicking and holding a mouse button or other type of user input device button. In response to such a request, the routine 500 branches to operation 506, where the display is fluidly zoomed in to show a full-scale representation of the selected scaled visual representation. From operation 516, the routine 500 continues to operation 518, where a determination is made as to whether the button has been released. When the button is released, the routine 500 continues from operation 518 to operation 520, where the display is fluidly zoomed out of the scaled visual representation to show the search results. From operation 520, the routine 500 continues to operation 522.

At operation 522, the browser 110 determines if a request has been made to zoom into one of the scaled visual representations, such as by selection of a scaled visual representation using the user input pointer 208 and a user input device. If such a request has been received, the routine 500 continues to operation 524, where the display is fluidly zoomed into the selected scaled visual representation thereby showing the full-scale representation of the selected search result. The user may then view, navigate, and otherwise interact with the full-scale representation of the search result. If the browser 110 receives a request to return to the search results, the routine 500 branches to operation 528, where the display is fluidly zoomed out of the full-scale representation to reveal the search results.

If, at operation 522, a request to zoom to a full-scale representation of a search result is not received, the routine 500 continues to operation 530. At operation 530 in FIG. 5B, the browser 110 determines whether a request has been received to temporarily zoom into the search results in a particular category. This may be accomplished, for instance, by moving the user input pointer 208 to a category name 210, and then clicking and holding a mouse button. In response to such a request, the routine 500 branches to operation 532, where the display is zoomed into the selected category to show additional detail and potentially additional search results for the selected category. This is described above with respect to FIGS. 4A-4C. If a request is received to return to the search results, such as by releasing the mouse button, the routine 500 branches from operation 534 to operation 536, where the display is fluidly zoomed out of the category view to return to the search results. From operation 536, the routine 500 continues to operation 538.

At operation 538, the browser 110 determines whether a request has been received to zoom into the search results in a particular category. This may be accomplished, for instance, by moving the user input pointer 208 to a category name 210, and then clicking a mouse button. In response to such a request, the routine 500 branches to operation 540, where the display is zoomed into the selected category to show additional detail and potentially additional search results for the selected category. This is described above with respect to FIGS. 4A-4C. If a request is received to return to the search results, the routine 500 branches from operation 542 to operation 544, where the display is fluidly zoomed out of the category view to return to the search results. From operation 544, the routine 500 continues to operation 546.

At operation 546, the browser 110 determines whether a request has been received to display additional search results. If not, the routine 500 branches back to operation 510 (shown in FIG. 5A), described above. If additional search results are to be displayed, the routine 500 continues from operation 546 to operation 548. At operation 548, the browser requests the additional search results from the search engine 114, renders the results, and displays them in the manner described above. The routine 500 then continues from operation 510, described above.

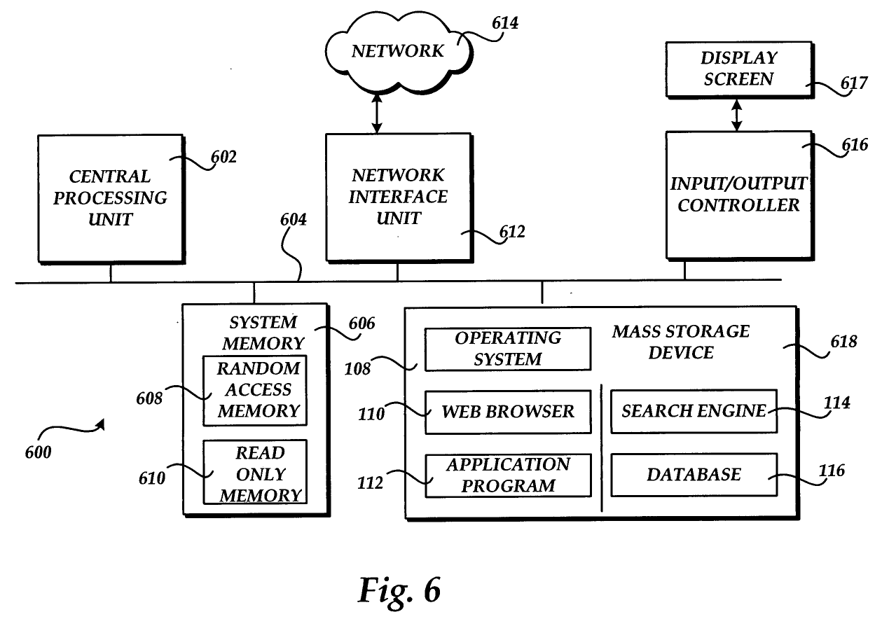

Referring now to FIG. 6, an illustrative computer architecture for a computer 600 utilized in the various embodiments presented herein will be discussed. The computer architecture shown in FIG. 6 illustrates a conventional desktop, laptop computer, or server computer. The computer architecture shown in FIG. 6 includes a central processing unit 602 (“CPU”), a system memory 608, including a random access memory 614 (“RAM”) and a read-only memory (“ROM”) 616, and a system bus 604 that couples the memory to the CPU 602. A basic input/output system containing the basic routines that help to transfer information between elements within the computer 600, such as during startup, is stored in the ROM 616. The computer 600 further includes a mass storage device 610 for storing an operating system 108, application programs, and other program modules, which will be described in greater detail below.

The mass storage device 610 is connected to the CPU 602 through a mass storage controller (not shown) connected to the bus 604. The mass storage device 610 and its associated computer-readable media provide non-volatile storage for the computer 600. Although the description of computer-readable media contained herein refers to a mass storage device, such as a hard disk or CD-ROM drive, it should be appreciated by those skilled in the art that computer-readable media can be any available media that can be accessed by the computer 600.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 600.

According to various embodiments, the computer 600 may operate in a networked environment using logical connections to remote computers through a network 106, such as the Internet. The computer 600 may connect to the network 106 through a network interface unit 606 connected to the bus 604. It should be appreciated that the network interface unit 606 may also be utilized to connect to other types of networks and remote computer systems. The computer 600 may also include an input/output controller 612 for receiving and processing input from a number of other devices, including a keyboard, mouse, or electronic stylus (not shown in FIG. 6). Similarly, an input/output controller may provide output to a display screen 617.

As mentioned briefly above, a number of program modules and data files may be stored in the mass storage device 610 and RAM 614 of the computer 600, including an operating system 108 suitable for controlling the operation of a networked desktop or server computer, such as the WINDOWS XP operating system from MICROSOFT CORPORATION of Redmond, Wash., or the WINDOWS VISTA operating system, also from MICROSOFT CORPORATION. The mass storage device 610 and RAM 614 may also store one or more program modules. In particular, the mass storage device 610 and the RAM 614 may store a Web browser program 110, a search engine 114, and the other program modules described above with respect to FIG. 1. Other program modules may also be stored in the mass storage device 610 and utilized by the computer 600.

It should be appreciated that although the embodiments presented herein have been described with respect to Web pages, the various implementations may be utilized with any type of search results provided by any type of search engine. Moreover, although the embodiments presented herein have been described in the context of a search engine accessible through the Internet, the embodiments presented herein can be used to visualize and navigate search results obtained by searching data stored on a single desktop computer. It should further be appreciated that some or all of the operations described herein as being performed by the browser 110 may be performed by other software components executing on the client computer 102, such as by the operating system 108 or the application program 112.

Based on the foregoing, it should be appreciated that systems, methods, and computer-readable media for visualizing and navigating search results are provided herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for visualizing and navigating a collection of search results, the method comprising:
rendering a scaled visual representation of each of a plurality of the search results; and
simultaneously displaying each scaled visual representation on a single display screen.

2. The method of claim 1, wherein the search results are organized into groups based upon one or more categories, and wherein each scaled visual representation is displayed within a corresponding group.

3. The method of claim 2, further comprising:
receiving a request to view a full-scale visual representation of a search result; and
in response to receiving the request to view a full-scale visual representation of a search result, fluidly zooming into a scaled visual representation corresponding to the search result to thereby display the full-scale visual representation of the search result on the display screen.

4. The method of claim 3, wherein the request to view a full-scale representation of a search result comprises a request to temporarily view the full-scale visual representation of the search result, and wherein the method further comprises fluidly zooming out of the full-scale visual representation of the search result to thereby show the simultaneous display of each scaled visual representation on the display screen.

5. The method of claim 2, wherein each of the categories includes one or more sub-categories, and wherein the method further comprises:
receiving a request to view additional detail for a selected category; and
in response to receiving the request to view additional detail for a category, simultaneously displaying scaled visual representations of search results in one or more sub-categories of the selected category.

6. The method of claim 2, further comprising:
receiving a request to view additional detail for a selected category; and
in response to receiving the request to view additional detail for the selected category, simultaneously displaying scaled visual representations of search results in the selected category.

7. The method of claim 6, further comprising increasing a size of the displayed scaled visual representations of search results in the selected category.

8. The method of claim 6, wherein simultaneously displaying scaled visual representations of search results in the selected category comprises displaying one or more additional visual representations of search results in the selected category.

9. A computer-readable medium having computer-executable instructions stored thereon which, when executed by a computer, cause the computer to:
generate a plurality of scaled visual representations of a plurality of search results; and to
present a display comprising the plurality of scaled visual representations of the search results on a single display screen.

10. The computer-readable medium of claim 9 having further computer-executable instructions stored thereon which, when executed by the computer, cause the computer to:
receive a request to view a full-scale visual representation of a selected scaled visual representation of a search result; and
in response to receiving the request to view a full-scale visual representation of a scaled visual representation of a search result, to fluidly zoom the display into the selected scaled visual representation of the search result to thereby display the full-scale visual representation of the selected scaled visual representation.

11. The computer-readable medium of 10 having further computer-executable instructions stored thereon which, when executed by the computer, cause the computer to fluidly zoom the display out of the full-scale visual representation of the selected search result to display the plurality of scaled visual representations of the search results.

12. The computer-readable medium of claim 9 having further computer-executable instructions stored thereon which, when executed by the computer, cause the computer to display the plurality of scaled visual representations of the search results in a plurality of groups, the plurality of groups based upon or more categories assigned to each of the search results.

13. The computer-readable of claim 12 having further computer-executable instructions stored thereon which, when executed by the computer, cause the computer to display a category name adjacent to each of the groups.

14. The computer-readable of claim 13 having further computer-executable instructions stored thereon which, when executed by the computer, cause the computer to:
receive a selection of a category name; and
in response to the selection of a category name, to display scaled visual representations of the search results in a category corresponding to the selected category name.

15. The computer-readable of claim 14 having further computer-executable instructions stored thereon which, when executed by the computer, cause the computer to increase a size of the scaled visual representations of the search results in the category corresponding to the selected category name in response to the selection of a category name.

16. The computer-readable of claim 14 having further computer-executable instructions stored thereon which, when executed by the computer, cause the computer to display one or more additional scaled visual representations of search results in the category corresponding to the selected category name in response to the selection of a category name.

17. The computer-readable medium of claim 14, wherein each of the categories is divided into one or more sub-categories, and wherein the computer-readable medium has further computer-executable instructions stored thereon which, when executed by the computer, cause the computer to display scaled visual representations of search results in one or more sub-categories of a category corresponding to the selected category name in response to the selection of a category name.

18. A method for visualizing and navigating a plurality of search results organized into a plurality of categories, the method comprising:
generating a scaled visual representation of each of a subset of the plurality of search results;
displaying the scaled visual representations in one or more groups, each group corresponding to one of the categories;
receiving a request to display a full-scale representation of a search result;
in response to the request to display a full-scale representation of a search result, fluidly zooming into a scaled visual representation of the search result to thereby display the full-scale representation of the search result; and
fluidly zooming out of the full-scale representation of the search result to thereby display the scaled visual representations of the search results in the one or more groups.

19. The method of claim 18, further comprising:
displaying a category name adjacent to each group;
receiving the selection of a category name; and
in response to receiving the selection of a category name, displaying scaled visual representations of search results within a category corresponding to the selected category name.

20. The method of claim 19, wherein each of the categories includes one or more sub-categories, and wherein the method further comprises:
in response to receiving the selection of the category name, displaying scaled visual representations of search results in a sub-category of the category corresponding to the selected category name.
